(19) United States
(12) Patent Application Publication
(10) Pub. No.: US 2006/0164336 A1
(43) Pub. Date: Jul. 27, 2006

(54) Plasma display, driving device and method of operating the same

(76) Inventors: Jin-Ho Yang, Suwon-si (KR); Jin-Sung Kim, Suwon-si (KR); Seong-Joon Jeong, Suwon-si (KR)

Correspondence Address: LEE & MORSE, P.C.;Attorneys and Counselors At Law, SUITE 2000, 1101 WILSON BOULEVARD, ARLINGTON, VA, 22209, US

(21) Appl. No.: 11/298,596

(22) Filed: Dec. 12, 2005

(30) Foreign Application Priority Data
Jan. 25, 2005 (KR) 10-2005-0006605

(51) Int. Cl. G09G 3/28

(52) U.S. Cl. 345/60

(57) ABSTRACT

In a driving circuit of a plasma display, a drain of a first transistor is coupled to a scan electrode and a switch driver is coupled between a gate and a source of the first transistor. The switch driver turns on the first transistor to reduce voltage of the scan electrode and charge a capacitor coupled to the source of the first transistor. When voltage across the capacitor is increased by a predetermined voltage, the first transistor is turned off and the scan electrode is floated. By repeating this operation, voltage of the scan electrode is gradually reduced. When a discharge is generated in a discharge cell of the plasma display by decreasing voltage of the scan electrode, voltage of the floated scan electrode is increased. The switch driver further discharges the capacitor when voltage variance of the floated scan electrode increases.

### BACKGROUND OF THE INVENTION

1. Field of the Invention

The present invention relates to plasma displays. More particularly, the present invention relates to devices and methods for controlling plasma displays.

2. Description of the Related Art

A plasma display is a display device that uses a plasma generated by gas discharge in discharge cells to display characters or images. Depending on its size, a plasma display panel (PDP) of the plasma display includes from more than several tens to millions of pixels arranged in a matrix pattern.

In the plasma displays, a frame is divided into a plurality of subfields, and each subfield includes a reset period, an address period, and a sustain period. The reset period is used to initialize the status of the discharge cells and facilitate addressing operations on the discharge cells. The address period is used for selecting turn-on/turn-off cells among the discharge cells, and the sustain period is used for causing the turn-on cells to continue the discharge, resulting in displaying an image on the PDP.

In a conventional plasma display, a ramp waveform is applied to a scan electrode to initialize the status of each discharge cell during the reset period. Specifically, a rising ramp waveform, which gradually rises, is applied to the scan electrode and is followed by a falling ramp waveform, which gradually falls. Since control of wall charges in a discharge cell strongly depends on the gradient of ramps in the applied ramp waveforms, the wall charges may not be precisely controlled.

### SUMMARY OF THE INVENTION

The present invention is therefore directed to plasma displays, and devices and methods for controlling the plasma displays, which substantially overcome one or more of the problems due to the limitations and disadvantages of the related art. In particular, the invention provides a plasma display facilitating precise control of wall charges in discharge cells.

At least one of the above and other features and advantages of the present invention may be realized by providing a plasma display including a plurality of first electrodes associated with discharge cells of the plasma display, a plurality of second electrodes associated with discharge cells of the plasma display and forming a capacitive load with the first electrodes, a first transistor having a first terminal coupled to the first electrodes, a first capacitor having a first terminal coupled to a second terminal of the first transistor and a second terminal coupled to a first power source for supplying a first voltage, a second transistor coupled between the first terminal of the first capacitor and a second power source for supplying a second voltage, and a first switch driver coupled to a control terminal of the second transistor and adapted for increasing a control terminal voltage at the second transistor when a voltage of the first electrodes is increased.

The first switch driver may include a first diode having a cathode coupled to the first electrodes, a first resistor coupled to the first diode in parallel, a second capacitor having a first terminal coupled to an anode of the first diode and a second terminal coupled to the control terminal of the second transistor, and a second diode having a cathode coupled to a second terminal of the second capacitor and an anode coupled to the second power source. The second diode may be a Zener diode. The control terminal of the first transistor may be adapted to a driving signal attaining a third voltage for turning on the first transistor and attaining a fourth voltage for turning off the first transistor.

The plasma display may also include a discharge path for discharging at least a portion of a charge accumulated by the first capacitor when the driving signal attains a fourth voltage. The discharge path may include a second resistor and a third diode coupled in serial to the second resistor and adapted for blocking current charging the first capacitor. The discharge path may further include a second switch driver adapted for outputting the driving signal through an output terminal, and the discharge path may be coupled between the first capacitor and the output terminal of the second switch driver. The first voltage may be equal to the second voltage.

At least one of the above and other features and advantages of the present invention may also be realized by providing a driving device of a plasma display having a plurality of first electrodes associated with discharge cells of the plasma display and a plurality of second electrodes associated with discharge cells of the plasma display and forming a capacitive load with the first electrodes. In one embodiment, the driving device includes a first transistor having a first terminal coupled to the first electrodes and a control terminal adapted for receiving a driving signal having a control signal attaining a first voltage and a second voltage, the first transistor adapted for being turned on in response to the first voltage of the control signal, a first capacitor having a first terminal coupled to a second terminal of the first transistor and a second terminal coupled to a first power source for supplying a third voltage, a discharge path coupled to the first terminal of the first capacitor, and adapted for discharging at least a portion of charges accumulated by the first capacitor; a second transistor coupled between the first terminal of the first capacitor and a second power source for supplying the fourth voltage, and a second capacitor coupled between a control terminal of the second transistor and the first terminal of the first transistor and adapted for changing a control terminal voltage of the second transistor in response to voltage variance at the first terminal of the first transistor in a state when the first transistor is turned off.

The driving device may further include a first diode coupled between the first terminal of the first transistor and the second capacitor, a first resistor coupled to the first diode in parallel, and a second diode coupled between the second capacitor and the second power source. A cathode of the first diode may be coupled to the first terminal of the first transistor and an anode of the second diode may be coupled to the second power source. The second diode may be a Zener diode.

The driving device may further include a switch driver adapted for outputting the driving signal through an output terminal, and the discharge path may include a third diode coupled between the first terminal of the first capacitor and the output terminal of the switch driver.

At least one of the above and other features and advantages of the present invention may further be realized by providing a driving method for a plasma display including a plurality of first electrodes associated with discharge cells of the plasma display and a plurality of second electrodes associated with discharge cells of the plasma display and forming a capacitive load with the first electrodes. The method may include the steps of turning on a first transistor having a first terminal coupled to the first electrodes in response to a first level of a control signal, discharging the capacitive load in response to turning on the first transistor, thereby charging a capacitor coupled to a second terminal of the first transistor and generating a discharge between the first electrodes and the second electrodes, turning off the first transistor in response to the charging the capacitor, changing a voltage of the first electrodes in response to the discharge between the first electrodes and the second electrodes, changing voltage at a control terminal of a second transistor coupled to the capacitor in response to voltage variance at the first electrodes, and discharging the capacitor in response to a second level of the control signal.

The method may further include at least one of a step of discharging the capacitor in response to voltage variance at the control terminal of the second transistor and a step of applying the control signal having alternating the first and second levels.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a schematic diagram of a plasma display according to one embodiment of the present invention;

FIG. 2 illustrates a series of timing diagrams of a driving waveform used in the plasma display of FIG. 1;

FIG. 3 illustrates a series of timing diagrams of voltage at the Y electrode and a discharge current generated by the driving waveform of FIG. 2 according to one embodiment of the present invention;

FIG. 4 illustrates a circuit diagram of a driving circuit according to a first exemplary embodiment of the present invention;

FIG. 5 illustrates a series of timing diagrams of a driving waveform generated using the driving circuit of FIG. 4;

FIG. 6 illustrates a circuit diagram of a driving circuit according to a second exemplary embodiment of the present invention;

FIG. 7 illustrates a series of timing diagrams of a driving waveform generated using the driving circuit of FIG. 6;

FIG. 8 illustrates a circuit diagram of a driving circuit according to a third exemplary embodiment of the present invention; and

FIG. 9 illustrates a series of timing diagrams of a driving waveform generated using the driving circuit of FIG. 8.

### DETAILED DESCRIPTION OF THE INVENTION

Korean Patent Application No. 10-2005-0006605, filed on Jan. 25, 2005 and entitled: “Plasma Display and Driving Device and Method Thereof” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Wall charges described in the present invention refer to charges formed on a portion of a wall of a discharge cell disposed close to a respective electrode and are accumulated on that electrode. The wall charges are also described as being “formed” or “accumulated” on the electrodes although such charges do not actually contact the electrodes. Further, the term “wall voltage” refers to a difference of potentials formed between the walls of the discharge cell by the wall charges.

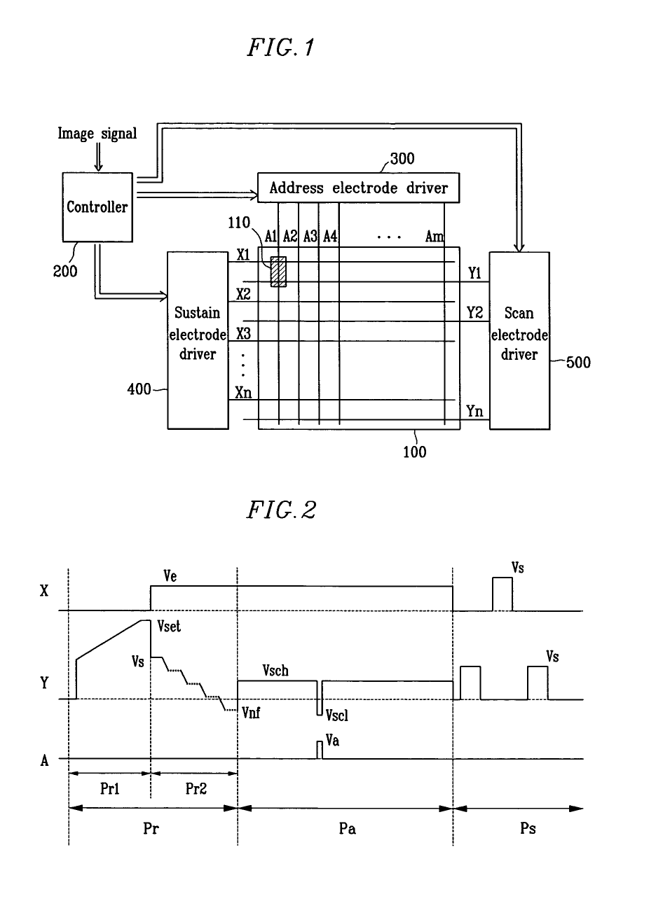

FIG. 1 illustrates a schematic diagram of a plasma display according to one embodiment of the present invention. As shown in FIG. 1, the plasma display may include a plasma display panel (PDP) 100, a controller 200, an address (A) electrode driver 300, a sustain (X) electrode driver 400, and a scan (Y) electrode driver 500.

The PDP 100 may include a plurality of address electrodes (referred to as “A electrodes” hereinafter) A₁ to Aₘ extending in a column direction, a plurality of sustain electrodes (referred to as “X electrodes” hereinafter) X₁ to Xₙ extending in a row direction, and a plurality of scan electrodes (referred to as “Y electrodes” hereinafter) Y₁ to Yₙ extending in the row direction. The X electrodes X₁ to Xₙ correspond to the respective Y electrodes Y₁ to Yₙ, and, together, the X and Y electrodes facilitate an operation resulting in displaying an image during a sustain period. The sub-pixel area delineating a discharge space (i.e., the space where the A electrode crosses the Y and X electrodes) defines a discharge cell 110.

In operation, the controller 200 receives image signals and outputs A electrode driving control signals, X electrode driving control signals, and Y electrode driving control signals. Additionally, the controller 200 divides a single frame into a plurality of subfields, each subfield having respective brightness weights, and drives the subfields. Each subfield includes, sequentially, a reset period, an address period, and a sustain period.

The Y electrode driver 500 receives the Y electrode driving control signals from the controller 200 and sequentially applies scan pulses to the Y electrodes Y₁ to Yₙ. The A electrode driver 300 receives the A electrode driving control signals from the controller 200 and selectively applies address pluses for selecting on-cells to the A electrodes A₁ to Aₘ each time when the scan pulse is applied to the Y electrode. As such, the discharge cell being formed by the A electrode receiving an address pulse and the Y electrode receiving a scan pulse is selected as an on-cell. The X electrode driver 400 and the Y electrode driver receive the X electrode driving control signals and the Y electrode driving control signals and apply sustain pulses to the X electrodes X₁ to Xₙ and the Y electrodes Y₁ to Yₙ, thereby performing a display operation for the on-cells.

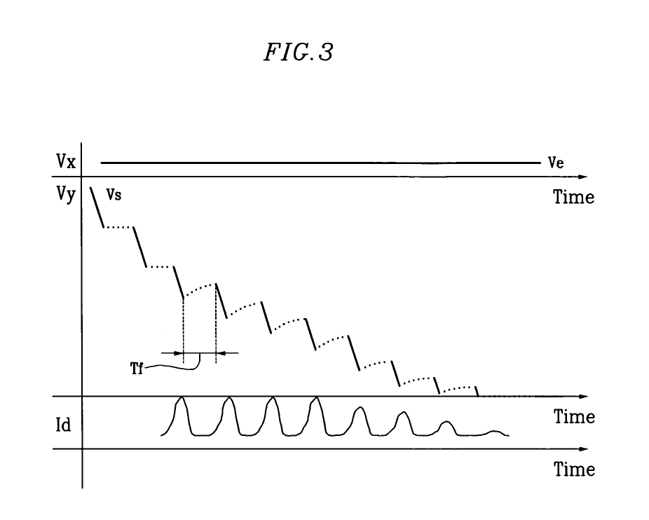

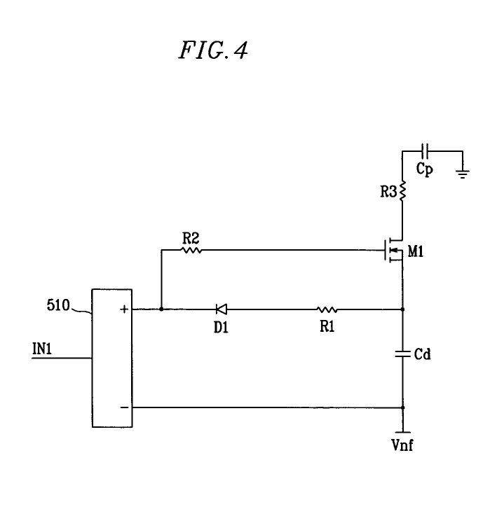

Driving waveforms applied to the A electrodes A₁ to Aₘ, the X electrodes X₁ to Xₙ, and the Y electrodes Y₁ to Yₙ during each subfield are described in reference to FIGS. 2 and 3, and a discharge cell formed using the A, X, and Y electrodes is discussed in detail in reference to FIGS. 2 through 9.

FIG. 2 illustrates a series of timing diagrams of a driving waveform used in the plasma display of FIG. 1, and FIG. 3 illustrates a series of timing diagrams of voltage at the Y electrode and a discharge current generated by the driving waveform of FIG. 2 according to one embodiment of the present invention.

Referring to FIG. 2, each subfield includes a reset period Pᵣ, an address period Pₐ, and a sustain period Pₛ. The reset period Pᵣ includes a rising period Pᵣ₁ and a falling period Pᵣ₂.

Voltage at the Y electrode is gradually increased from voltage Vₛ to voltage Vₛₑₜ, while a ground potential (0V) is applied to the X electrode and the A electrode during the rising period Pᵣ₁ of the reset period Pᵣ. Weak reset discharges are generated between the Y electrode and the A electrode, as well as between the X electrode and the Y electrode, causing negative charges to be formed on the Y electrode and positive charges to be formed on the A electrode and the X electrode, respectively.

As shown in FIGS. 2 and 3, a process is repeated in which voltage of the Y electrode is reduced by a predetermined voltage and the Y electrode is floated by limiting voltage applied to the Y electrode during a period T_{f}, while voltage Vₑ is applied to the X electrode in the falling period Pᵣ₂ of the reset period Pᵣ.

When a difference between the X electrode voltage Vₓ and the Y electrode voltage V_{y} becomes greater than a discharge firing voltage during such a process, a discharge occurs between the X electrode and the Y electrode, and a discharge current I_{d} begins flowing in the discharge space.

The Y electrode is floated after the discharge has started between the X electrode and the Y electrode. The Y electrode voltage V_{y} changes according to an amount of the wall charges, because no electric charge is supplied to the Y electrode from the power source. The amount of the wall charges formed on the X electrode and the Y electrode is reduced by the discharge between the X electrode and the Y electrode, therefore voltage within the discharge space is rapidly reduced. When voltage between the X electrode and the Y electrode becomes smaller than the discharge firing voltage, the discharge is rapidly quenched. In addition, as shown in FIG. 3, voltage of the floated Y electrode is increased, because the X electrode is maintained at the voltage Vₑ when voltage within the discharge space is reduced. As such, the discharge may be quenched while the wall charges are only slightly erased, because voltage within the discharge space varies according to changes in the wall charges.

Subsequently, the Y electrode is floated when the Y electrode voltage V_{y} is reduced to cause the discharge, and the discharge is rapidly quenched in the discharge space, while the wall charges formed at the Y and X electrodes are slightly erased. By repeating this operation, the wall charges formed at the Y and X electrodes may be erased in steps, thereby providing control of the wall charges as they reach a desired state.

Referring to FIG. 2 again, in the address period Pₐ for selecting turn-on cells, a scan voltage V_{scl} and an address voltage Vₐ are applied to Y electrode and A electrode of the turn-on cell, respectively. A non-selected Y electrode is biased at a voltage of V_{sch} which is higher than the scan voltage V_{scl}, and the ground potential (0V) is applied to the A electrode of the cell being turned off. In the sustain period Pₛ, the voltage Vₛ and the ground voltage 0V are applied to the Y electrode and the X electrode in turn so that the turn-on cell is sustain-discharged.

In this embodiment, as described above, the discharge may be quenched by a small amount of wall charges, thus allowing control over the wall charges. A conventional reset method based on applying a ramp voltage slowly reduces the Y electrode voltage to prevent an intense discharge and provide control of the wall charge. Such a reset method uses the ramp voltage to control intensity of the discharge by using a slope of the ramp voltage and restricting gradient of the slope of the ramp to certain acceptable slope values in order to control the wall charges. However, restriction of the slope values may result in increased duration of the reset period Pᵣ. Since the present invention facilitates rapid quenching of the discharge by employing floating of the Y electrode, the Y electrode voltage may be rapidly reduced. As a result, the reset period in a plasma display according to the present invention may be shorter than in a plasma display where a reset period is defined using the ramp voltage.

While the falling period Pᵣ₂ of the reset period Pᵣ has been described in reference to an embodiment of the present invention, a discharge quenching mechanism described above may also be used when the wall charges are controlled using the ramp voltage. In addition, while the waveform for reducing the Y electrode voltage has been described in reference to the embodiment of the present invention, the discussed discharge quenching mechanism may also be applicable to a waveform used to increase the Y electrode voltage V_{y}. For example, the Y electrode voltage V_{y} may gradually be increased by repeating the operation of floating the electrode after increasing the voltage V_{y} by a predetermined voltage.

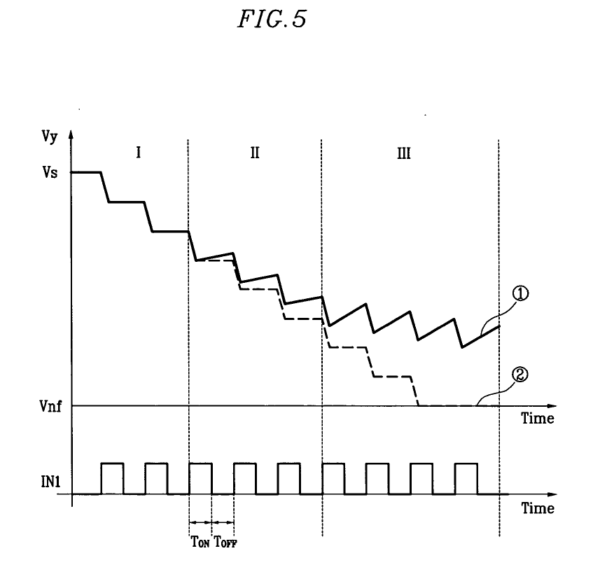

An exemplary driving circuit for generating a waveform that is similar or identical to that shown in FIG. 3 is described below in reference to FIGS. 4 and 5. Such driving circuits may, e.g., be provided in the Y electrode driver 500 for generating the Y electrode waveforms shown in FIG. 2.

FIG. 4 illustrates a circuit diagram of a driving circuit according to a first exemplary embodiment of the present invention, and FIG. 5 illustrates a series of timing diagrams of a driving waveform generated using the driving circuit of FIG. 4. A panel capacitor Cp shown in FIG. 4 represents a capacitive load between the Y and X electrodes. It is assumed that a ground potential is applied to a second terminal of the panel capacitor Cp (i.e., the X electrode), and that the panel capacitor Cp is charged with a predetermined amount of charge.

As shown in FIG. 4, the driving circuit according to the first exemplary embodiment includes a transistor M1, capacitors Cp and Cd, a resistor R1, optional resistors R2 and R3, a diode D1, and a switch driver 510. In FIG. 4, the transistor M1 is depicted as an n channel MOSFET (metal oxide semiconductor field effect transistor), but other switches suitable for performing functions similar to those described below may be used instead of the n channel MOSFET.

A drain, which is one of two main terminals of the transistor M1, is coupled to a first terminal (i.e. the Y electrode) of the panel capacitor Cp, and a source, which is the other main terminal of the transistor M1, is coupled to a first terminal of the capacitor Cd. A second terminal of the capacitor Cd and a negative polarity terminal of the switch driver 510 are coupled to a power source for supplying voltage V_{nf}. A positive polarity terminal of the switch driver 510 is coupled to a gate of the transistor M1, which is the control terminal of the transistor M1, and a negative polarity terminal of the switch driver 510 is coupled to the power source V_{nf}. The switch driver 510 supplies a driving signal for driving the transistor M1 in response to a control signal IN1. Voltage of the driving signal is higher than the voltage V_{nf} by a value of voltage V_{cc} when the control signal IN1 is at a high level and is equal to the voltage V_{nf} when the control signal IN1 is at a low level.

In one embodiment, the resistor R2 is coupled between the positive polarity terminal of the switch driver 510 and the gate of the transistor M1. The diode D1 and the resistor R1 are coupled between the first terminal of the capacitor Cd and the positive polarity terminal of the switch driver 510 and, together, form a discharging path for the capacitor Cd.

Operation of the driving circuit of FIG. 4 is described with reference to FIG. 5. In FIG. 5, a waveform I (depicted as a solid line) corresponds to a case when a discharge is generated between the Y electrode and the X electrode, and a waveform II (depicted as a dotted line) corresponds to a case when no discharge is generated between the Y electrode and the X electrode.

As shown in FIG. 5, when the control signal IN1 is at a high level (i.e., during a time interval T_{ON}), gate voltage of the transistor M1 becomes higher than source voltage of the transistor M1 by a value of the voltage V_{cc}, and, as such, the transistor M1 is turned on. Subsequently, the charge accumulated in the panel capacitor Cp is moved to the capacitor Cd, and the Y electrode voltage V_{y} is reduced. When the capacitor Cd is charged, voltage at the first terminal of the capacitor Cd increases and the source voltage of the transistor M1 increases. During this time, gate voltage of the transistor M1 is maintained at the same level as at the time of turning on the transistor M1, but voltage at the first terminal of the capacitor Cd increases. Therefore, source voltage of the transistor M1, in comparison to gate voltage of the transistor M1, increases. When source voltage of the transistor M1 increases to a predetermined voltage, voltage between the gate and the source of the transistor M1 becomes lower than a threshold voltage Vₜ of the transistor M1, and the transistor M1 is turned off.

When the transistor M1 is turned off, voltage applied to the Y electrode of the panel capacitor Cp is stabilized and the Y electrode of the panel capacitor Cp is floated. An amount of charge ΔQi charged in the capacitor Cd when the transistor M1 is turned off may be defined using Equation 1:
ΔQᵢ=C_{d}(V_{cc}−Vₜ) (1)

where Cd is capacitance of the capacitor Cd.

When the control signal IN1 is at the low level (i.e., during a time interval TOFF), voltage at the positive polarity terminal of the switch driver 510 becomes lower than the first terminal voltage of the capacitor Cd, and the capacitor Cd is discharged through a discharge path including the capacitor Cd, the diode D1, the resistor R1 and the switch driver 510. Because the capacitor Cd is discharged from a state when the capacitor Cd is charged to a voltage (Vcc−Vt), an amount ΔVd of a voltage drop across the capacitor Cd by the discharge may be defined using Equation 2:

$$Δ {V}_{d} = ( {V}_{cc} - {V}_{t} ) {ⅇ}^{- \frac{1}{{R}_{1} {C}_{d}} t} \qquad ( 2 )$$

where R1 is the resistance of the resistor R1.

In addition, an amount of charge ΔQd discharged from the capacitor Cd during the time interval TOFF of the control signal IN1, may be defined using Equation 3:

$$\begin{matrix}Δ {Q}_{d} = {C}_{d} ( {V}_{cc} - {V}_{t} ) - {C}_{d} ( {V}_{cc} - {V}_{t} ) {ⅇ}^{- \frac{1}{{R}_{1} {C}_{d}} {T}_{OFF}} \\ = {C}_{d} ( {V}_{cc} - {V}_{t} ) ( 1 - {ⅇ}^{- \frac{1}{{R}_{1} {C}_{4}} {T}_{OFF}} )\end{matrix} \qquad ( 3 )$$

Accordingly, an amount of charge Qd remaining in the capacitor Cd may be defined using Equation 4:
Q_{d}=ΔQᵢ−ΔQ_{d} (4)

When the control signal IN1 attains a high level, the transistor M1 is turned on, and the charge is subsequently moved from the panel capacitor Cp to the capacitor Cd. As described above, the transistor M1 is turned off when the charge ΔQᵢ is moved from the panel capacitor Cp to the capacitor Cd. Referring to FIG. 5, when there is no discharge between the Y electrode and the X electrode during an early stage of the falling period I, voltage of the floated Y electrode remains unchanged. When the discharge is generated between the Y electrode and the X electrode, voltage of the floated Y electrode is increased, as shown in FIG. 5 in reference to periods II and III.

As described above, when the transistor M1 is turned on in response to a high level of the control signal IN1, the Y electrode voltage V_{y} is reduced by a predetermined value, voltage across the capacitor Cd is increased by another predetermined value, and the transistor M1 is turned off. When the control signal IN1 attains a low level, the capacitor Cd becomes discharged, and the transistor M1 remains in a turned-off state. Such cycles of reducing voltage of the Y electrode and floating the Y electrode are repeated when the control signal IN1 alternates between the high and low levels.

While the discharge path of the capacitor Cd has been described as coupled to the positive polarity terminal of the switch driver 510, the discharge path may also be formed using a different path. For example, a switch (not shown) may be coupled between the first terminal of the capacitor Cd and the power source V_{nf} and turned on to form a discharge path. Additionally, as shown in FIG. 4, a resistor R3 may be coupled between the panel capacitor Cp and the transistor M1 to restrict the current discharging from the panel capacitor Cp. Furthermore, other elements (not shown) suitable for restricting the current discharged from the panel capacitor Cp (e.g., inductor) may be used instead of the resistor R3.

Intense discharge may be generated by priming particles formed, in a previous discharge cycle, during a last stage of the reset period III. When the intense discharge is generated, voltage variance of the floated Y electrode increases, while a rate of decreasing the Y electrode voltage V_{y} is low. A rate of decreasing of the Y electrode voltage V_{y}, when the discharge is generated between the Y electrode and the X electrode, is substantially different from such a rate when there is no discharge between the Y electrode and the X electrode. Therefore, duration of the reset period Pᵣ should be extended in consideration of the intense discharge.

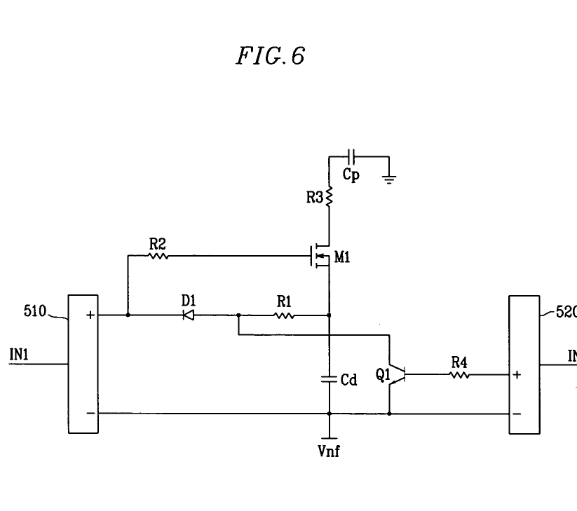

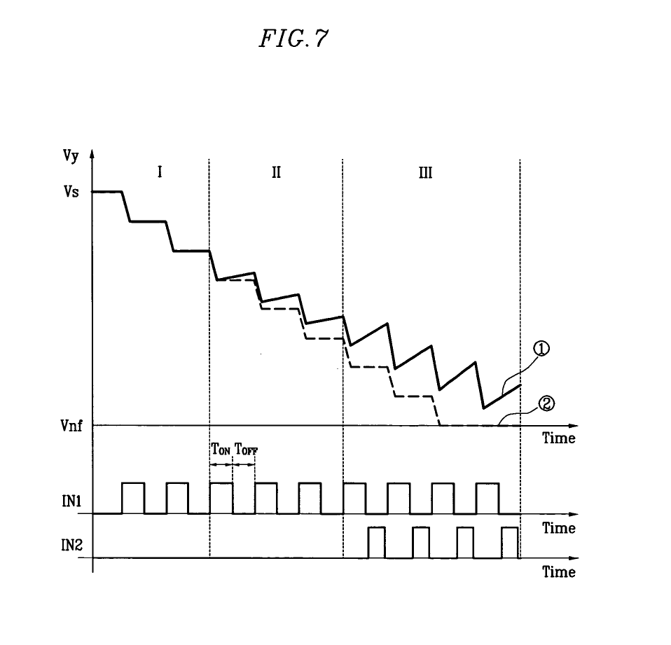

Exemplary embodiments for rapidly reducing the Y electrode voltage Vy when the intense discharge is generated during the last stage of the reset period are described below in reference to FIGS. 6 through 9.

FIG. 6 illustrates a circuit diagram of a driving circuit according to a second exemplary embodiment of the present invention, and FIG. 7 illustrates a series of timing diagrams of a driving waveform generated using the driving circuit of FIG. 6.

As shown in FIG. 6, the driving circuit according to the second exemplary embodiment, as compared to the first exemplary embodiment, further includes a transistor Q1, an optional resistor R4, and a switch driver 520. In FIG. 6, the transistor Q1 is depicted as an npn bipolar junction transistor (BJT), but other switches suitable for performing functions similar to those described below may be used instead of the npn BJT.

Specifically, a collector of the transistor Q1, which is one of two main terminals of the transistor Q1, is coupled to a common point of the resistor R1 and the diode D1, and an emitter of the transistor Q1, which is the other main terminal of the transistor Q1, is coupled to the second terminal of the capacitor Cd and, as such, to the power source V_{nf}. Alternatively, the collector of the transistor Q1 may also be coupled to the first terminal of the capacitor Cd. A positive polarity terminal of the switch driver 520 is coupled to a base of the transistor Q1, which is a control terminal of the transistor Q1, and a negative polarity terminal of the switch driver 520 is coupled to the power source V_{nf}. The switch driver 520 supplies a driving signal for driving the transistor Q1 in response to a control signal IN2. This driving signal turns on the transistor Q1 when the control signal IN2 is at a high level, and turns off the transistor Q1 when the control signal IN2 is at a low level, respectively. The resistor R4 may be coupled between the positive polarity terminal of the switch driver 520 and the base of the transistor Q1.

The operation of the driving circuit of FIG. 6 is described in reference to FIG. 7. A waveform in a region III of FIG. 7 is described below, whereas a waveform in regions I and II of FIG. 7 is similar to the waveform of FIG. 5.

As shown in FIG. 7, the control signal IN2 attains alternating high and low levels when the voltage V_{y} of the floated Y electrode is changed by intense discharge during the last stage of the reset period III. In particular, the control signal IN2 attains a high level when the control signal IN1 attains a low level.

When the control signal IN2 is at a high level and the control signal IN1 is at a low level, a charge accumulated in the capacitor Cd is discharged through discharge paths formed by the transistor Q1 and the diode D1. Because the charge is discharged from the capacitor Cd, as compared to the first exemplary embodiment, an amount of the charge remaining in the capacitor Cd is less than could be defined using Equation 3.

When the control signal IN2 is at a low level and the control signal IN1 is at a high level, the transistor Q1 is turned off and the transistor M1 is turned on, resulting in that the charge is moved from the panel capacitor Cp to the capacitor Cd, as compared to the region II where the charge has been discharged from the capacitor Cd. Therefore, the Y electrode voltage V_{y} is reduced, as compared to the region II.

As described above, since the Y electrode voltage V_{y} is reduced when the voltage V_{y} of the floated Y electrode is increased by the intense discharge, a rate of decreasing the Y electrode voltage V_{y} cannot be low in the region III.

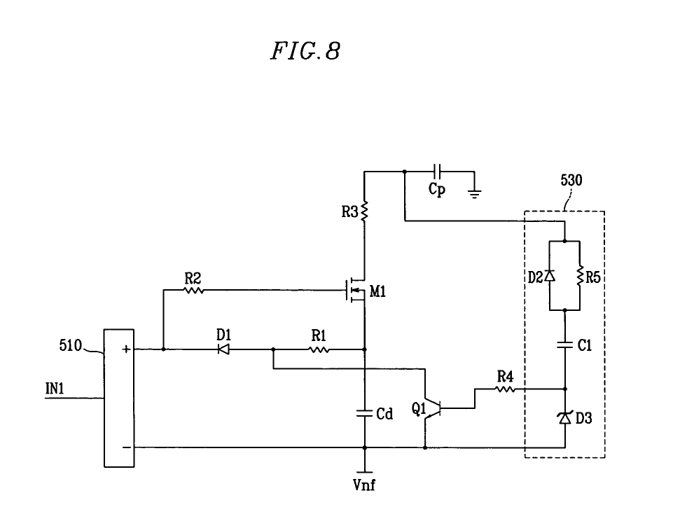

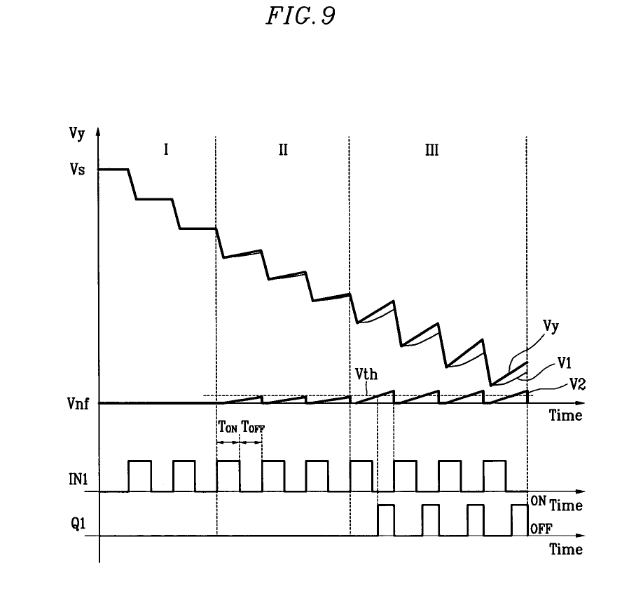

In the driving circuit of FIG. 6, the control signal IN2 is provided to the switch driver 520 to drive the transistor Q1. An exemplary embodiment for controlling the transistor Q1 without the control signal IN2 is described below in reference to FIGS. 8 and 9.

FIG. 8 depicts a circuit diagram illustrating a driving circuit according to a third exemplary embodiment of the present invention, and FIG. 9 depicts a series of timing diagrams illustrating a driving waveform of the driving circuit of FIG. 8.

As shown in FIG. 8, the driving circuit according to the third exemplary embodiment further includes a switch driver 530, as compared to the discussed above first exemplary embodiment, and the switch driver 530 may not be driven by a control signal.

Specifically, the switch driver 530 includes diodes D2 and D3, a resistor R5, and a capacitor C1. A cathode of the diode D2 is coupled to the first terminal of the panel capacitor Cp (i.e., the Y electrode), and an anode of the diode D2 is coupled to a first terminal of the capacitor C1. The resistor R4 is coupled to the diode D2 in parallel, and a second terminal of the capacitor C1 is coupled to the base of the transistor Q1. An anode of the diode D3, which cathode is coupled to the first terminal of the capacitor C1, is coupled the power source Vnf.

It is assumed that voltage V1 at the first terminal of the capacitor C1 becomes equal to the Y electrode voltage V_{y} of the panel capacitor Cp prior to a state when the control signal IN1 firstly attains a high level, and voltage V2 at the second terminal of the capacitor C1 is equal to the voltage V_{nf}.

When the transistor M1 is turned on by the control signal IN1 having a high level, the Y electrode voltage V_{y} becomes reduced, resulting in forward biasing of the diodes D2 and D3. Then, voltage at terminals of the capacitor C1 is reduced by a value of voltage variance of the panel capacitor Cp, as shown in FIG. 9.

The Y electrode voltage V_{y} is increased by a predetermined voltage in a state when the transistor M1 is turned off, and the diodes D2 and D3 become reverse biased. Subsequently, voltages V1 and V2 across the capacitor C1 are increased due to a current flowing from the panel capacitor Cp through the resistor R5 to the capacitor C1.

When voltage variance of the panel capacitor Cp becomes greater than a predetermined voltage, as in a case discussed in reference to the region III, variance of the second terminal voltage V2 of the capacitor C1 may become larger than a threshold voltage of the transistor Q1. Subsequently, the transistor Q1 is turned on, and the capacitor Cd may be further discharged. As such, since the switch driver 530 can perform the same function as the switch driver 520 shown in FIGS. 6 and 7, the control signal IN2 may not be provided.

The Y electrode voltage V_{y} may be changed during a period in which the control signal IN1 does not provide input to the switch driver 510. As shown in FIG. 8, the diode D3 may be a Zener diode in order to protect base voltage of the transistor Q1 when the Y electrode voltage V_{y} is changed.

While only the waveform of the Y electrode has been described in the discussed above exemplary embodiments, these exemplary embodiments may also be applicable to the waveforms used to drive the A electrodes and the X electrodes.

Embodiments of the present invention provide a driving circuit for repeatedly floating the electrode of a discharge cell after making the voltage applied to the electrode to fall. Additionally, in the discussed embodiments of the invention, using the floating operations, wall charges formed in the discharge cells of the plasma display are precisely controlled.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display, comprising:
a plurality of first electrodes associated with discharge cells of the plasma display;
a plurality of second electrodes associated with discharge cells of the plasma display and forming a capacitive load with the first electrodes;
a first transistor having a first terminal coupled to the first electrodes;
a first capacitor having a first terminal coupled to a second terminal of the first transistor and a second terminal coupled to a first power source for supplying a first voltage;
a second transistor coupled between the first terminal of the first capacitor and a second power source for supplying a second voltage; and
a first switch driver coupled to a control terminal of the second transistor and adapted for increasing a control terminal voltage of the second transistor when a voltage at the first electrodes is increased.

2. The plasma display as claimed in claim 1, wherein the first switch driver comprises:
a first diode having a cathode coupled to the first electrodes;
a first resistor coupled to the first diode in parallel;
a second capacitor having a first terminal coupled to an anode of the first diode and a second terminal coupled to the control terminal of the second transistor; and
a second diode having a cathode coupled to a second terminal of the second capacitor and an anode coupled to the second power source.

3. The plasma display as claimed in claim 2, wherein the second diode is a Zener diode.

4. The plasma display as claimed in claim 1, wherein a control terminal of the first transistor is adapted to a driving signal attaining a third voltage for turning on the first transistor and attaining a fourth voltage for turning off the first transistor.

5. The plasma display as claimed in claim 4, further comprising a discharge path for discharging at least a portion of a charge accumulated by the first capacitor during a period when the driving signal attains a fourth voltage.

6. The plasma display as claimed in claim 5, wherein the discharge path comprises:
a second resistor; and
a third diode coupled in serial to the second resistor and adapted for blocking current charging the first capacitor.

7. The plasma display as claimed in claim 6, further comprising:
a second switch driver adapted for outputting the driving signal through an output terminal,
wherein the discharge path is coupled between the first capacitor and the output terminal of the second switch driver.

8. The plasma display as claimed in claim 1, wherein the first voltage is equal to the second voltage.

9. A driving device of a plasma display including a plurality of first electrodes associated with discharge cells of the plasma display and a plurality of second electrodes associated with discharge cells of the plasma display and forming a capacitive load with the first electrodes, the driving device comprising:
a first transistor having a first terminal coupled to the first electrodes and a control terminal adapted for receiving a driving signal having a control signal attaining a first voltage and a second voltage, the first transistor adapted for being turned on in response to the first voltage of the control signal;
a first capacitor having a first terminal coupled to a second terminal of the first transistor and a second terminal coupled to a first power source for supplying a third voltage;
a discharge path coupled to the first terminal of the first capacitor, and adapted for discharging at least a portion of charges accumulated by the first capacitor;
a second transistor coupled between the first terminal of the first capacitor and a second power source for supplying the fourth voltage; and
a second capacitor coupled between a control terminal of the second transistor and the first terminal of the first transistor and adapted for changing a control terminal voltage of the second transistor in response to voltage variance at the first terminal of the first transistor in a state when the first transistor is turned off.

10. The driving device as claimed in claim 9, further comprising:
a first diode coupled between the first terminal of the first transistor and the second capacitor;
a first resistor coupled to the first diode in parallel; and
a second diode coupled between the second capacitor and the second power source.

11. The driving device as claimed in claim 10, wherein a cathode of the first diode is coupled to the first terminal of the first transistor and an anode of the second diode is coupled to the second power source.

12. The driving device as claimed in claim 11, wherein the second diode is a Zener diode.

13. The driving device as claimed in claim 9, further comprising:
a switch driver adapted for outputting the driving signal through an output terminal,
wherein the discharge path comprises a third diode coupled between the first terminal of the first capacitor and the output terminal of the switch driver.

14. A driving method for a plasma display including a plurality of first electrodes associated with discharge cells of the plasma display and a plurality of second electrodes associated with discharge cells of the plasma display and forming a capacitive load with the first electrodes, the driving method comprising:
turning on a first transistor having a first terminal coupled to the first electrodes in response to a first level of a control signal;
discharging the capacitive load in response to turning on the first transistor, thereby charging a capacitor coupled to a second terminal of the first transistor and generating a discharge between the first electrodes and the second electrodes;
turning off the first transistor in response to charging the capacitor;
changing voltage at the first electrodes in response to the discharge formed between the first electrodes and the second electrodes;
changing voltage at a control terminal of a second transistor coupled to the capacitor in response to voltage variance at the first electrodes; and
discharging the capacitor in response to a second level of the control signal.

15. The driving method as claimed in claim 14, further comprising:
discharging the capacitor in response to voltage variance at the control terminal of the second transistor.

16. The driving method as claimed in claim 14, further comprising:
applying the control signal having alternating the first and second levels.
